(19) United States
(12) Patent Application Publication
(10) Pub. No.: US 2025/0379283 A1
(43) Pub. Date: Dec. 11, 2025

(54) METHOD OF STRUCTURAL BATTERY COOLING PLATE DESIGN FOR ELECTRIC OR HYBRID VEHICLE OR ELECTRICAL ENERGY STORAGE SYSTEM APPLICATION

(71) Applicant: Canoo Technologies Inc., Torrance, CA (US)

(72) Inventors: Yuhang Chen, Torrance, CA (US); Bashar Khasawneh, Torrance, CA (US); Sai Jayant Bhogaram, Torrance, CA (US); Sanchita Sanjay Surve, Torrance, CA (US); Amit Ranjan, Royal Oak, MI (US); Oscar Francisco Cervantes Huacuja, Torrance, CA (US); Yi-Hsien Liu, Torrance, CA (US); Israel Debro, Torrance, CA (US)

(21) Appl. No.: 18/739,048

(22) Filed: Jun. 10, 2024

(51) Int. Cl. H01M 10/6554; B60L 50/64; H01M 10/613; H01M 10/625; H01M 50/213; H01M 50/291

(52) U.S. Cl. CPC H01M 10/6554; B60L 50/64; H01M 10/613; H01M 10/625; H01M 50/213; H01M 50/291; H01M 2220/20

(57) ABSTRACT

Manufacture and quality control of a cooling plate is simplified by providing peripheral walls on each side of a fluid cavity within a metallic base. The peripheral walls protrude over external surfaces of a fluid cavity and encircle open recesses. The external surface of the fluid cavity on one side of the base may be a metallic lid surrounded by a ledge inside the peripheral walls on the respective side and over the fluid cavity, joined to the base by friction stir welding. Plastic honeycomb cell receptacle structures within the open recesses on each side of the base may be snap fit to counterpart features on the peripheral walls. Defects arising from machining, e-coating, or powder coating metallic cell pockets on the cooling plate are avoided, as are defects related to gravity casting of the base for some embodiments.

### TECHNICAL FIELD

This disclosure relates generally to batteries used in electric or hybrid vehicles or electrical energy storage systems. More specifically, this disclosure relates to a system and method for thermal management in a battery module.

### BACKGROUND

Various electrically powered systems (e.g., electric vehicles, a/k/a “EVs”) use battery packs to store electrical energy, within which battery performance depends on temperature. For example, most lithium-ion batteries have a relatively narrow optimal operating range outside of which efforts to charge or discharge the batteries may cause damage to the batteries or even lead to unsafe conditions, especially when the batteries are overheated. Thermal management of battery packs is challenging, especially for the large battery packs used in EVs. Depending on ambient temperature conditions and functional needs of charging/discharging, batteries may need to be heated or cooled. The term “cooling plate” (or “cold plate”) as used in this disclosure refers to a device which facilitates heat transfer between the battery cells and the coolant which ultimately transfers the heat energy to and from an external system—e.g., the ambient environment.

Designs for “cold plates,” thermal management structures for large battery packs, are described in (for example) U.S. Patent Application Publication No. 2020/0220132A1, the content of which is incorporated herein by reference.

### SUMMARY

The present disclosure provides a cooling plate for a battery, and a method for producing a cooling plate, with a base having peripheral walls on both sides and a central recess offset from the peripheral walls.

In a first embodiment, a battery module cooling plate includes a base having a first side and a second side. The base includes first walls projecting from a periphery of the base on the first side and second walls projecting from the periphery of the base on the second side. The first side of the base includes a recessed region spaced apart from the first walls and forming a fluid cavity. The cooling plate also includes a lid over the recessed region. The cooling plate further includes a first honeycomb battery cell receptacle structure within the first walls on the first side of the base and over the lid, and a second honeycomb battery cell receptacle structure within the second walls on the second side of the base.

In various embodiments, the base, the lid, the first honeycomb structure, and the second honeycomb structure are all separately formed and assembled to function as a single device.

In various embodiments, a periphery of the recessed region is spaced apart from the first walls by a distance accommodating a friction stir welding tool head, and a periphery of the recessed region includes a lip indented by a distance corresponding to a thickness of the lid and projecting under an edge of the lid by an amount sufficient for friction stir welding of the lid to the lip of the recessed region in the base.

In various embodiments, the recessed region may include a peninsular lid support extending therein, the peninsular lid support having a width sufficient for friction stir welding of the lid to an upper surface of the peninsular lid support.

In various embodiments, the peninsular lid support may include a projecting flange received by a counterpart groove within the lid.

In various embodiments, a separation between the first walls may differ from a separation between the second walls to accommodate thermal expansion during friction stir welding of the lid to the base.

In various embodiments, the first and second honeycomb battery cell receptacle structures may each include: an array of cylindrical pockets each sized to receive a battery cell; projecting bottom legs supporting the respective one of the first honeycomb battery cell receptacle structure on a surface of the first side of the base and the lid or the second honeycomb battery cell receptacle structure on a surface of the second side of the base; and posts extending upwardly around each of the cylindrical pockets to facilitate dropping of a battery cell into a corresponding cylindrical pocket.

In various embodiments, the first and second honeycomb battery cell receptacle structures may each include snap fit projections at locations around a periphery, each snap fit projection configured to be received by an indentation in one of the first walls or the second walls.

In various embodiments, a battery module includes the battery module cooling plate, and further includes a battery cell within each battery cell pocket of the first and second honeycomb battery cell receptacle structures. The battery module further includes adhesive securing each battery cell within the corresponding battery cell pocket.

In various embodiments, an electric vehicle includes the battery module, and further includes a platform supporting the battery module, a cabin mounted on the platform, and wheels rotatably mounted on the platform.

Other technical features may be readily apparent to one skilled in the art from the following figures, descriptions, and claims.

### BRIEF DESCRIPTION OF THE DRAWINGS

For a more complete understanding of this disclosure and its advantages, reference is now made to the following description taken in conjunction with the accompanying drawings, in which like reference numerals represent like parts:

FIG. 1 illustrates an example electric vehicle for which a battery cooling plate may be manufactured according to embodiments of the present disclosure;

FIG. 2 illustrates an example vehicle platform of an electric vehicle for which a battery cooling plate may be manufactured according to embodiments of the present disclosure;

FIGS. 3 and 3A-3B illustrate an example battery cooling plate;

FIG. 4 illustrates a sand core used to form the internal coolant cavity of the battery cooling plate of FIGS. 3 and 3A-3B;

FIGS. 5 and 6 depict machining artifacts within battery cell pockets for the battery cooling plate of FIGS. 3 and 3A-3B;

FIGS. 7, 8, and 9 depict e-coating defects within battery cell pockets for the battery cooling plate of FIGS. 3 and 3A-3B;

FIG. 10 e-coating depicts defects resulting from contaminants on top of the e-coating within battery cell pockets for the battery cooling plate of FIGS. 3 and 3A-3B;

FIGS. 11 and 12 depict powder defects within battery cell pockets for the battery cooling plate of FIGS. 3 and 3A-3B;

FIG. 13 illustrates a vertical cold plate racking orientation during powder coating;

FIG. 14 depicts excessive base coating thickness for a powder coating;

FIG. 15 depicts thin coating thickness for a powder coating;

FIGS. 16A through 16M depict various view of a battery cooling plate or components thereof for a battery cooling plate manufactured according to embodiments of the present disclosure;

FIG. 17 diagrammatically illustrates a manufacturing assembly for friction stir welding of the lid to the base on a cooling plate according to embodiments of the present disclosure; and

FIGS. 18A through 18D depict various view of a battery cooling plate manufactured according to alternative embodiments of the present disclosure.

### DETAILED DESCRIPTION

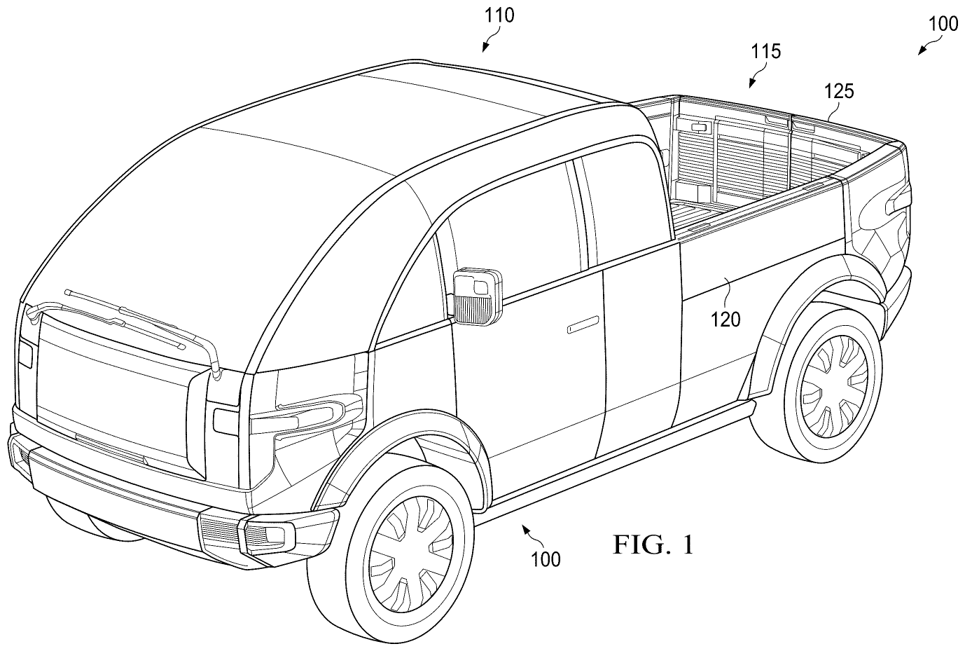

FIGS. 1-2, 16A-16M, 17, and 18A-18D, described below, and the various embodiments used to describe the principles of this disclosure are by way of illustration only and should not be construed in any way to limit the scope of this disclosure. Those skilled in the art will understand that the principles of this disclosure may be implemented in any type of suitably arranged device or system.

FIG. 1 illustrates an example electric vehicle for which a battery cooling plate may be manufactured according to embodiments of the present disclosure. The embodiment of the vehicle 100 illustrated in FIG. 1 is for illustration and explanation only. FIG. 1 does not limit the scope of this disclosure to any particular implementation of a vehicle.

In the example illustrated in FIG. 1, the vehicle 100 includes a top hat structure coupled to an electric vehicle platform. The platform of vehicle 100 of FIG. 1 includes a chassis (not visible in FIG. 1) supporting a cabin 110 for carrying passengers. In some embodiments, the chassis of the vehicle 100 is in the form of a “skateboard” vehicle platform supporting one or more energy storage elements (such as batteries) that provide input electrical power used by various components of the EV, such as one or more electric motors of the vehicle 100 and a control system of the vehicle 100 described in further detail below. The top hat structure is designed and dimensioned to have a crew cabin (“cab”) 110 and a cargo bed 115. The cabin 110 is configured to provide a space for one or more persons to sit and either operate or ride in the vehicle. The cargo bed 115 comprises an open area enclosed by a rear surface of the crew cab 110, side panels 120, and a rear gate 125.

Passengers may enter and exit the cabin 110 through at least one door forming part of the cabin 110. A transparent windshield and other transparent panels mounted within and forming part of the cabin 110 allow at least one passenger (referred to as the “operator,” even when the vehicle 100 is operating in an advanced driving or “AD” mode) to see outside the cabin 110. Rear-view mirrors mounted to sides of the cabin 110 enable the operator to see objects to the sides and rear of the cabin 110 and may include warning indicators (such as selectively illuminated warning lights) for features such as blind spot warning (indicating that another vehicle is in the operator's blind spot) and/or lane departure warning.

The cabin 110 is preferably dimensioned to accommodate a vehicle operator and at least one passenger. For example, the cabin 110 can be configured with a driver scat and passenger seat. The cabin 110 can include interior lighting and climate control systems, such as articulating, heated or cooled seats, and air vents coupled to an external source, a cabin heater, and an air condition unit. In certain embodiments, the cabin 110 includes a number of device holders, such as recesses to accommodate a beverage and recesses to accommodate one or more electronic devices. In certain embodiments, one or more of the surfaces or configured to attach various modular components. For example, one or more of the lateral surfaces may include a peg-board grid, webbing, picatinny rails, magnetic, electro-magnetic, hook and loop fasteners, and the like.

In certain embodiments one or more of the cabin 110 or cargo bed 115 includes one or more electrical outlets. The electrical outlets can be 110 volts or 220 volts. For example, a first electrical outlet can be 110 volts while a second electrical outlet is 220 volts. Conventional automobile features such as headlamps, taillights, turn signal indicators, windshield wipers, and bumpers are also depicted. The vehicle 100 may further include cargo storage within or connected to the cabin 110 and mounted on the chassis, and the cargo storage area(s) may optionally be partitioned by dividers from the passenger area(s) of the cabin 110.

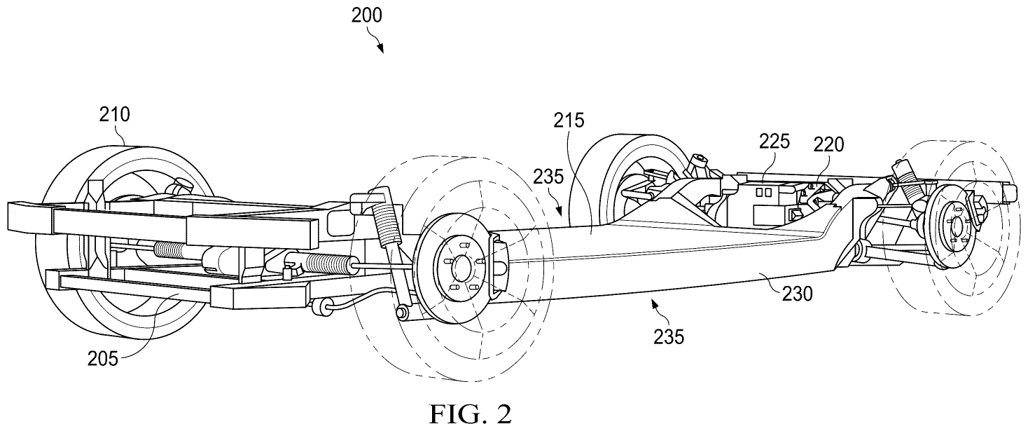

The platform, which described in further detail below in connection with FIG. 2, includes a chassis for the top hat structure including the cabin 110 and cargo bed 115. Wheels mounted on axles that are supported by the chassis and driven by the motor(s) via drive gears (all not visible in FIG. 1) allow the vehicle 100 to move smoothly. The wheels are mounted on the axles in a manner permitting rotation relative to a longitudinal centerline of the vehicle 100 for steering and are also connected to steering controls (not visible).

Although FIG. 1 illustrates one example of a vehicle 100, those skilled in the art will recognize that the full structure and operation of a suitable vehicle are not depicted in the drawings or described here. Instead, for simplicity and clarity, only the structures and operations necessary for an understanding the present disclosure are depicted and described. Various changes may be made to the example of FIG. 1, and the features described in this disclosure may be used with any other suitable vehicle.

FIG. 2 illustrates an example vehicle platform of an electric vehicle for which a battery cooling plate may be manufactured according to embodiments of the present disclosure. The embodiment of the vehicle platform 200 illustrated in FIG. 2 is for illustration and explanation only. FIG. 2 does not limit the scope of this disclosure to any particular implementation of a vehicle platform.

According to embodiments of this disclosure, a vehicle platform 200 includes a base frame 205. The base frame 205 can include coupling mounts configured to connect wheels 210 to the base frame 205. In some embodiments, the base frame 205 includes a battery pack 215 integrated therein. The vehicle platform 200 includes one or more electric drivetrain units, such as a rear drivetrain unit (RDU) 220 and a front drivetrain unit (FDU) 225.

The base frame 205 can be made of any suitable material, such as carbon steel, aluminum alloys, and the like. The base frame 205 includes one or more rails 230 that extend laterally along a length of the vehicle platform 200. The rails 230 are configured to form lateral edges of a battery compartment or battery containment unit. The base frame 205 can further include one or more panels 235 configured to extend horizontally on top and bottom portions of the rails 230. In certain embodiments, the rails 230 and panels are configured to form the battery compartment integrated into the base frame 205. The battery compartment is further configured to house the components of the battery pack 215.

In certain embodiments, the base frame 205 includes a charger. The charger is coupled to a charging port, which is configured to be selectively coupled to an external power source, such as a wall socket, or electric power connector. The charger can receive alternating current (AC) electrical energy and convert the AC electrical energy into a direct current (DC) electrical energy to charge the battery pack 215.

Although FIG. 2 illustrates one example of a vehicle platform 200, various changes may be made to FIG. 2. For example, the vehicle platform 200 could include any number of each component in any suitable arrangement. In general, vehicle systems come in a wide variety of configurations, and FIG. 2 does not limit the scope of this disclosure to any particular configuration. Also, while FIG. 2 illustrates one vehicular configuration in which various features disclosed in this patent document can be used, these features could be used in any other suitable system.

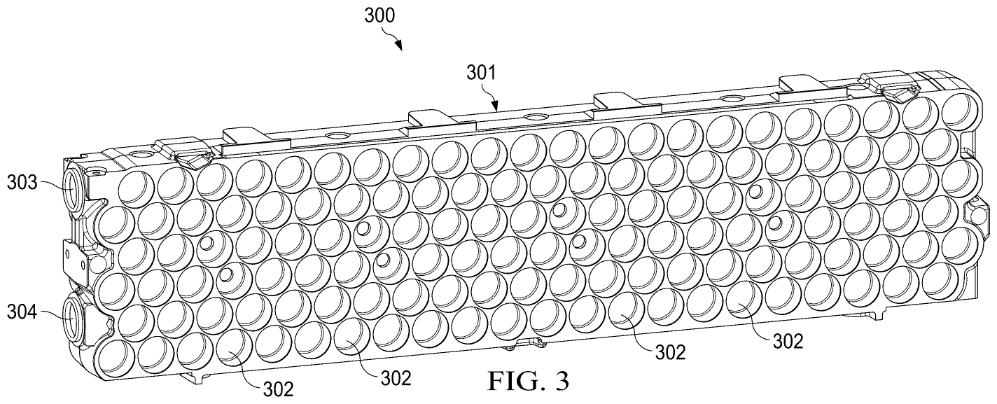

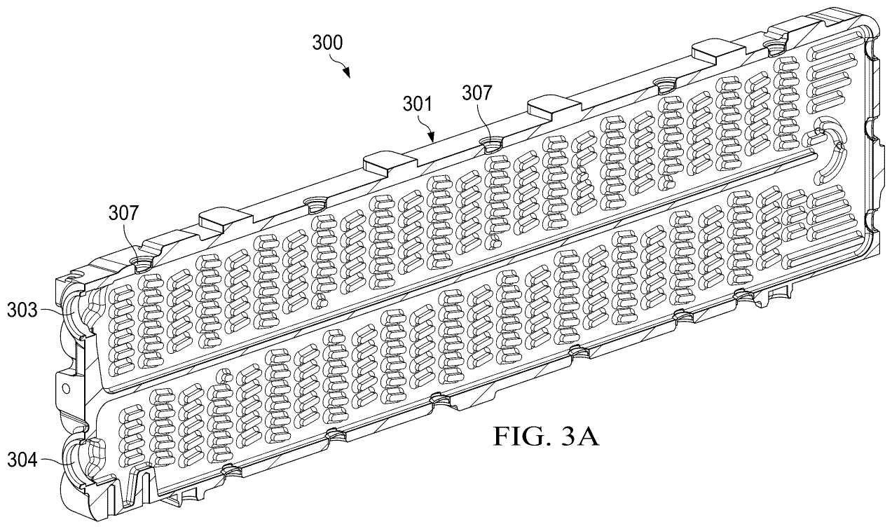

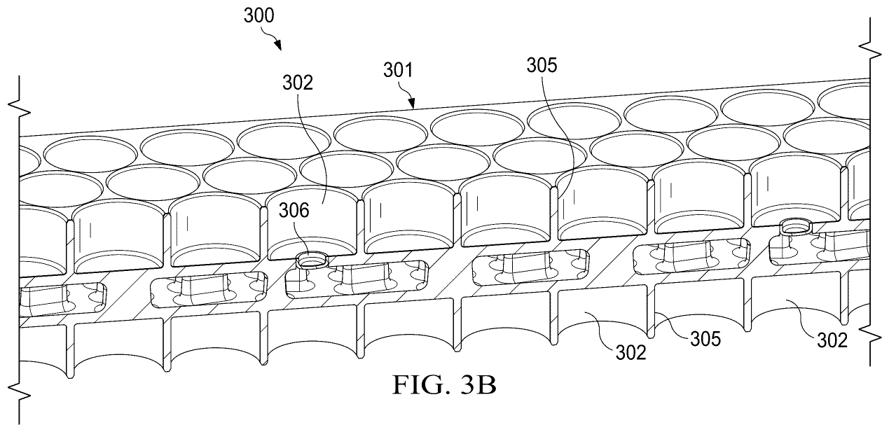

FIGS. 3 and 3A-3B illustrate an example battery cooling plate. The battery cooling plate 300 is a one-piece design based on gravity casting, computer numerical control (CNC) machining, e-coating, and powder coating. Battery cooling plate 300 is a multifunctional part that has major functionality including: mechanical support for the battery module assemblies, including direct support of all battery cells; electrical isolation of battery cells from each other; and provision of a flow path for liquid coolant. To meet those functional requirements, the design is a very complex, with cell pockets for mounting the cylindrical cells while also providing an internal cavity for liquid coolant for heat transfer. Due to the complex geometry, battery cooling plate 300 is not design-for-manufacture (DFM) friendly, with high percentages of scrapped parts during manufacturing due to defects that will—or may—eventually lead to the failure or deterioration of product's functionality.

Battery cooling plate 300 comprises a monolithic component 301 including a plurality of battery cell pockets 302 each configured to receive a cylindrical battery. The component 301 includes an internal coolant cavity (visible in longitudinal sectional view of FIG. 3A) and thermal fluid ports 303, 304 through which fluid flows into and out of the coolant cavity. A pattern of raised projections inside the coolant cavity directs coolant flow therein. As shown in the transverse sectional view of FIG. 3B, adjoining cell pockets 302 are separated by long, thin walls 305.

One approach to fabricating thermal plate 300 involves a gravity casting process. In a gravity casting process, a sand core 400 (illustrated in FIG. 4) is used to form the internal coolant cavity. Once the casting process is complete, the sand core is heated to become sand powder, which can be released from the cavity. However, from a gravity casting perspective, the design of battery cooling plate 300 is ill-suited due to the 264 cell pockets—features that have a very deep well with thin wall thickness, which can lead to air trapped in areas, and that has a porosity usually formed during the casting process once the molten aluminum is solidified. A number of issues may be encountered during gravity casting. First, the long, thin walls 305 between adjacent cell pockets 302 are difficult to form by gravity casting, and may lead to porosity issues. Second, the internal cavity of battery cooling plate 300, made using the sand core that has to be positioned right in the center of the cooling plate by the positioning pins leaves positioning holes once the sand core is released that must be machined in order to be sealed by the steel plugs. That is, the sand core 400 includes end protrusions 401 corresponding to thermal fluid ports 303, 304 through the walls of the component 301 around the coolant cavity, but also includes face protrusions 402 and peripheral edge protrusions 403. The face protrusions 402 result in holes 306 through the floor of certain cell pockets 302, and the peripheral edge protrusions 403 result in holes 307 through the peripheral edge of the component 301. Because of the machining of those holes, deburrs are usually created, fell into the coolant cavity and get stuck inside, which make this product not meet the cleanliness requirement. Machining of such holes 306, 307 can lead to burrs stuck inside the coolant cavity.

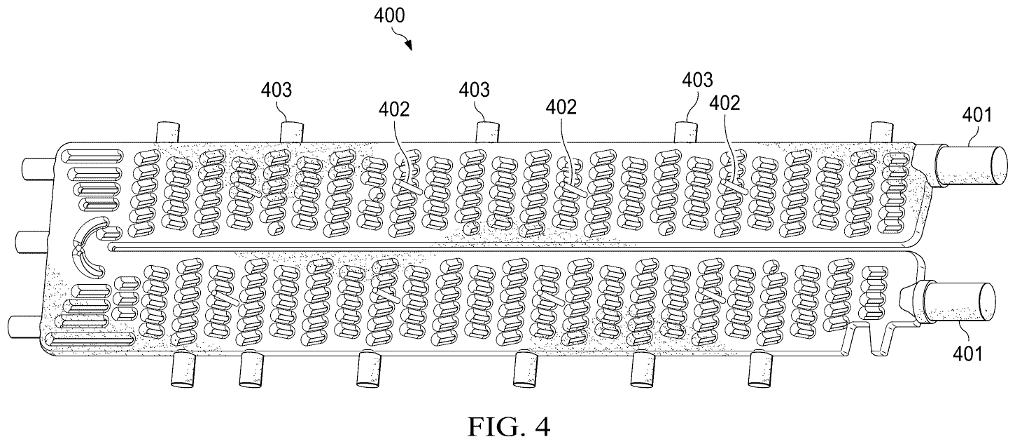

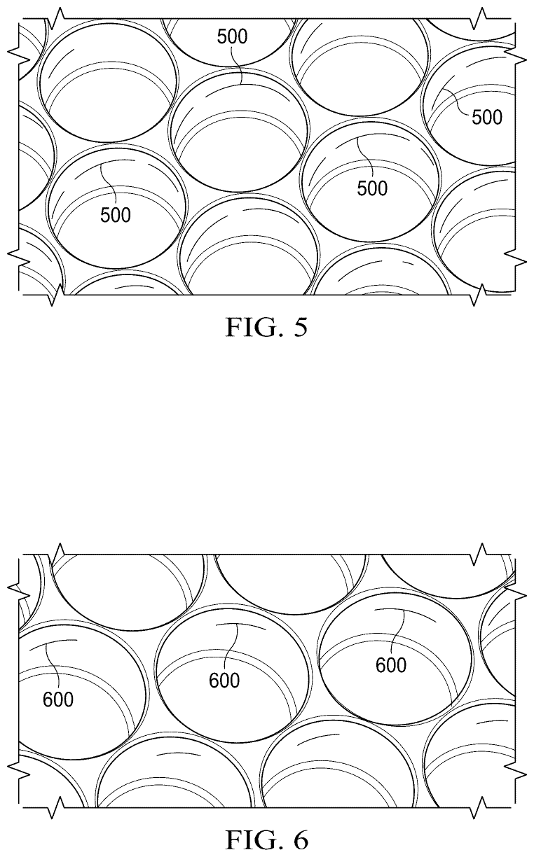

When necessary to complete a battery cooling plate, machining can also lead to other issues, such as rough side walls within battery cell pockets. From a machining perspective, the 264 cell pockets need to be machined to meet surface roughness and dimension requirements. However, if one cell pocket is out of specification, the entire part needs to be scrapped. For instance, spiral marks 500 or other scoring 600 on the cell pocket side walls, such as those illustrated in FIGS. 5 and 6, and rough surface finish can result in high potential (HiPot) dielectric testing failure, with breakdown/burn-through over the spiral marks 500 and/or scoring 600. The spiral marks 500 and/or scoring 600, which may remain visible even after e-coating and powder coating, are typically caused by machining parameters and tool selection. The peaks and valleys in substrate onto which dielectric is formed results in sections of lower coating thickness and eventually lower dielectric protection. One solution is slower speed/feed during machining, but that increases the costs of production.

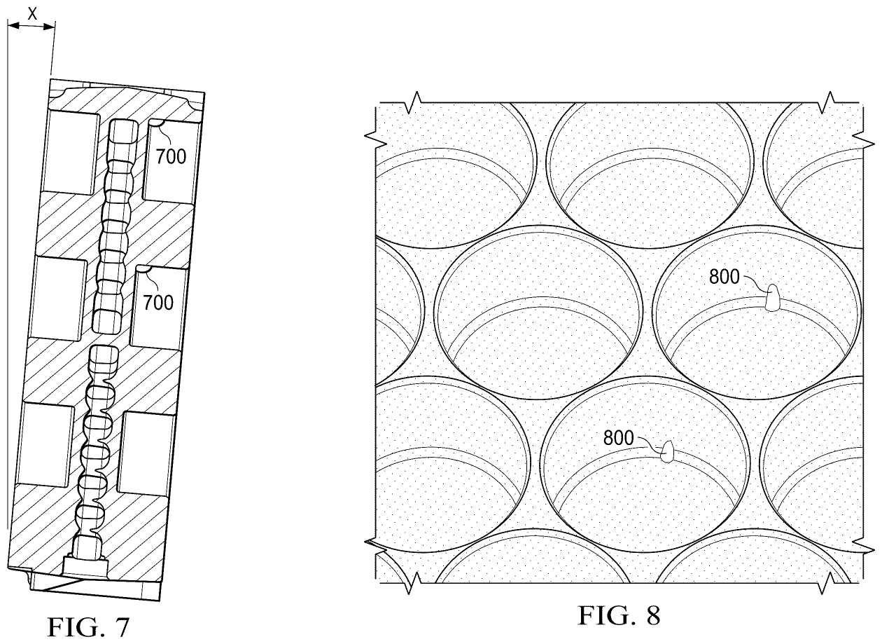

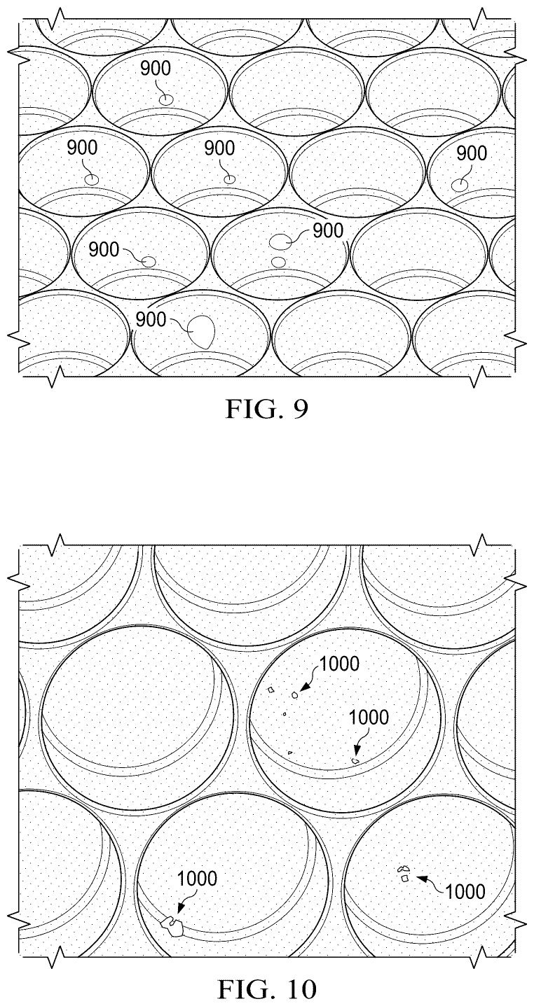

From a coating perspective, each cell pocket has to be coated with a required coating thickness, and with no bumps or bubbles allowed. This is quite challenging because the pocket is relatively deep (e.g., 14 millimeters (mm)), and special care is needed to ensure no contaminants remain in the pockets before coating lest defects such as uneven coating thickness and/or bumps result. By way of illustration, bare spot defects 800, 900 within e-coating of a battery cooling plate design are depicted by FIGS. 8, and 9. As diagrammatically illustrated by FIG. 7, a slight misorientation of the battery cooling plate during e-coating can result in small air pockets/bubbles 700 forming on the inside of the cups for the battery cell pockets when the battery cooling plate is dipped in e-coat tanks, hindering the flow of solution to these areas. At such bare spot defects 800, 900, illustrated in FIGS. 8 and 9, lack of the e-coating may result in lower dielectric protection.

Contaminants after e-coating (on top of the e-coat), illustrated in FIG. 10, may result when debris from the cooldown oven, racks, or the conveyor, and general particulate matter settles on the cold plate between e-coating and powder coating. Such defects 1000 may result in a potential no-build (interference) situation for battery cells to be placed inside the cup for that battery cell pockets, since easier dielectric breakdown exists where there are foreign contaminants. Pre-powder coat cleaning step(s) are not 100% effective at eliminating such contaminants.

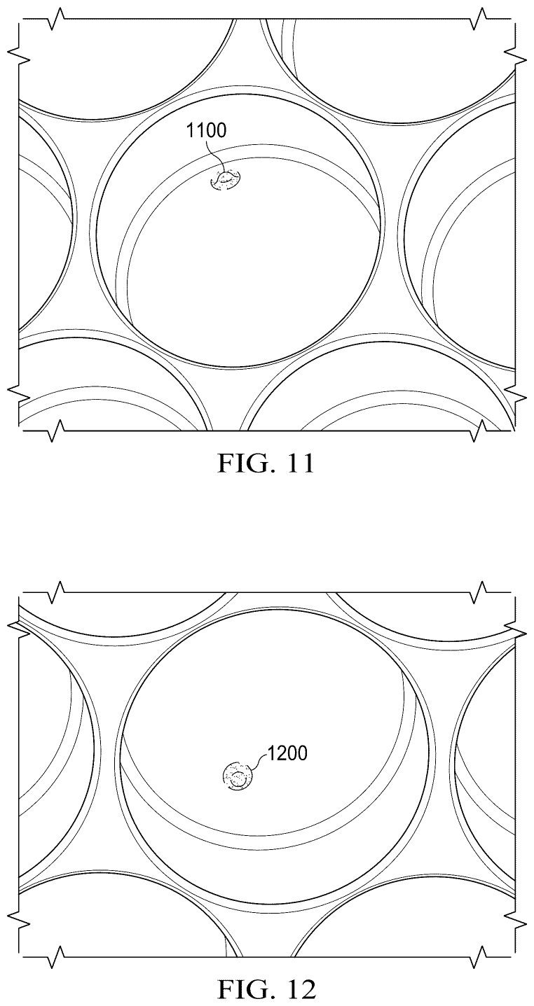

Contaminants 1100, 1200 under the power coating, illustrated in FIGS. 11 and 12, can cause the battery cell to sit higher (a no-build condition) and result causing high potential (HiPot) dielectric testing (functional) failure. That cell placement issue will result in current collector welding problems. Cleanliness on the production line, as by use of Class A booth spray, will reduce the occurrence, but may not completely solve the problem.

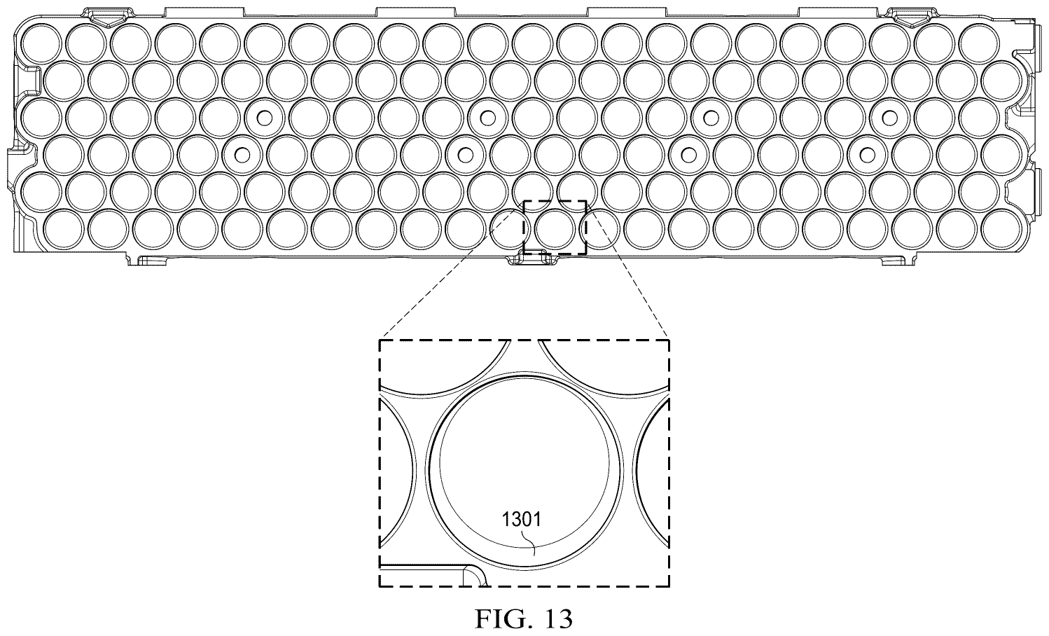

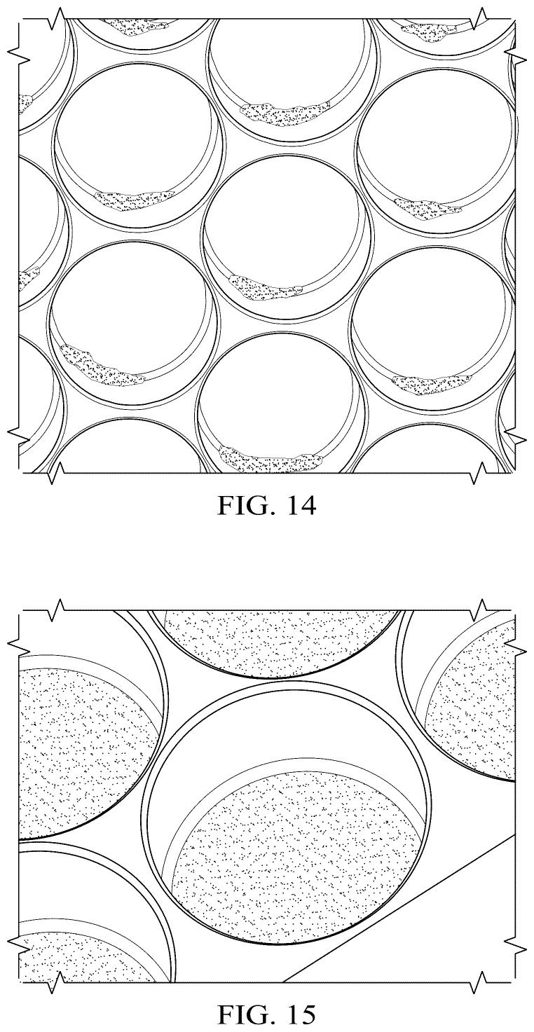

Other power coating defects arise from uneven powder coating on either the battery cell pocket sidewall or the battery cell pocket base. As illustrated in FIG. 13, a vertical cold plate racking orientation during powder coating can produce a coat 1301 with uneven thickness inside the cups for the battery cell pockets, on the sidewall, as powder flows down in the direction of gravity causing slightly increased thickness on the bottom side. This causes cell placement and/or position issue(s) that may affect welding of the current collector, and a potential no-build. Using a lighter coat (e.g., 50 to 100 microns (μm)) can suppress the welding issue, but is like to affect high potential dielectric testing performance at the cold plate level. On the other hand, a nominally horizontal cold plate racking orientation during powder coating can produce excessive powder build up on the base of the cell cup, as illustrated in FIG. 14. During manual spraying, in particular, more powder than required may be deposited and then flow down (in the direction of gravity). The excessive base coating thickness may result in a no-build condition, and while controlled spray aiming for lower thickness within tolerance is possible, spraying remains manual. A side effect of this issue is the potential for a thin coating in certain areas as illustrated in FIG. 15, causing an orange peel surface and a high potential dielectric testing failure risk.

In order to improve the robustness of the cooling plate, to address the issues discussed above, a cooling plate design according to the present disclosure is composed of four pieces: A and B side plastic honeycomb structures, made using injection molding with an acrylonitrile-butadiene-styrene terpolymer blend/polycarbonate (ABS+PC) composite material; and a cooling plate base and cooling plate lid made either using the high pressure die casting with aluminum B390 or semi-solid die casting with aluminum A357-T5 material. The cooling plate base is designed to include computational fluid dynamics (CFD)-optimized fins and channels to improve the rate of heat transfer for the system and reduce coolant pressure drop. The cooling plate base and lid are secured using friction stir welding. The honeycomb structures are mounted on cooling plate using mating structures such as projections arranged for snap fit with counterpart indentations, and are designed to maintain required cell-to-cell spacing to meet dielectric insulation requirements. The honeycomb structures also help to avoid adding coating for insulation because plastics are naturally a good electrical insulation material. Bottom legs on the honeycomb structure are designed to benefit cell adhesive dispensing and curing, yielding faster takt time and better quality (more uniform adhesive distribution, and better aeration of adhesive).

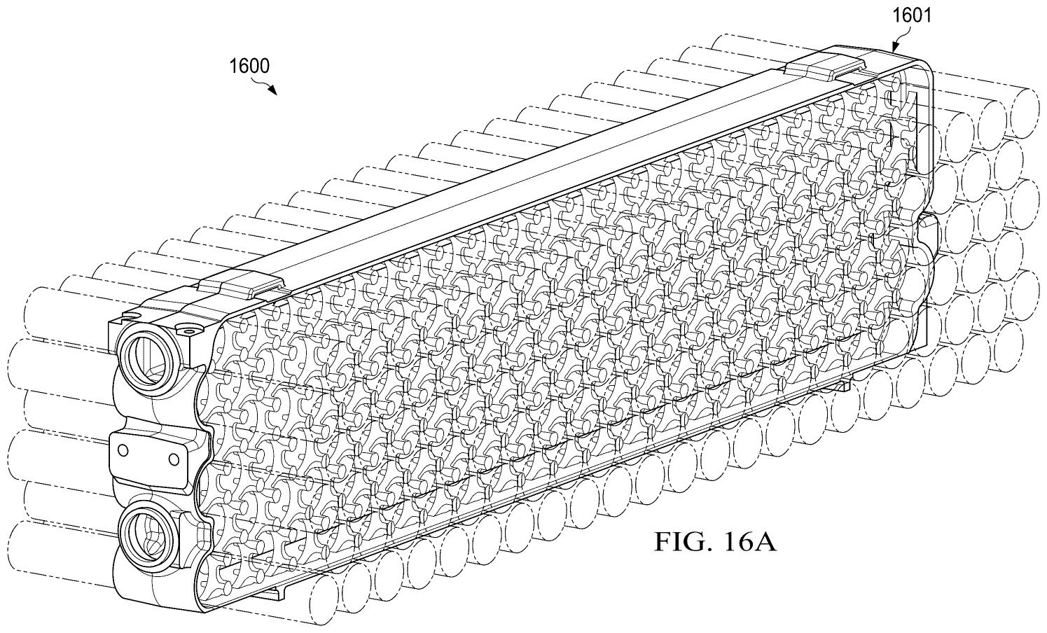

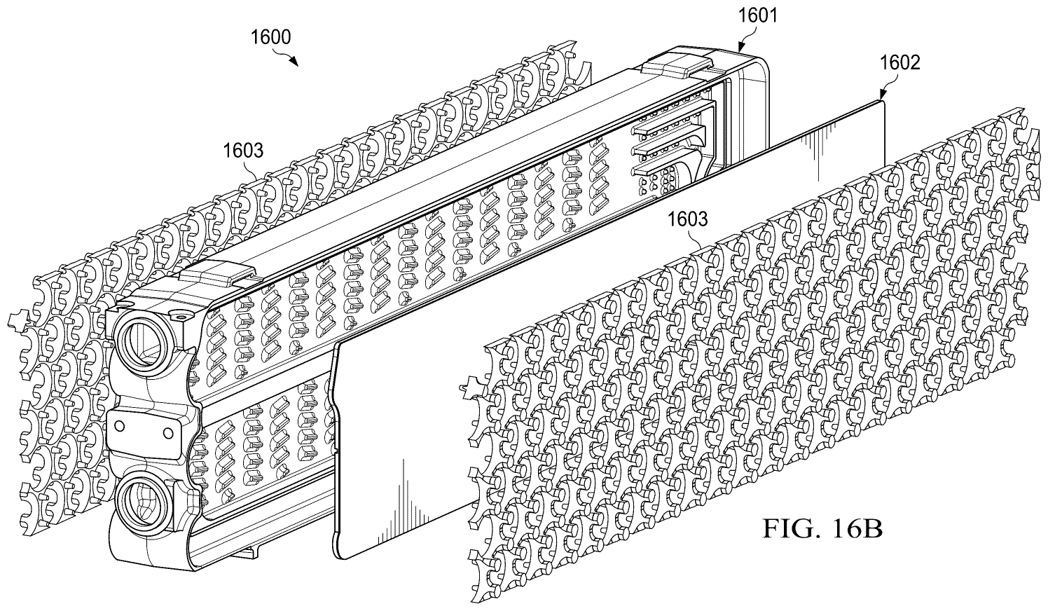

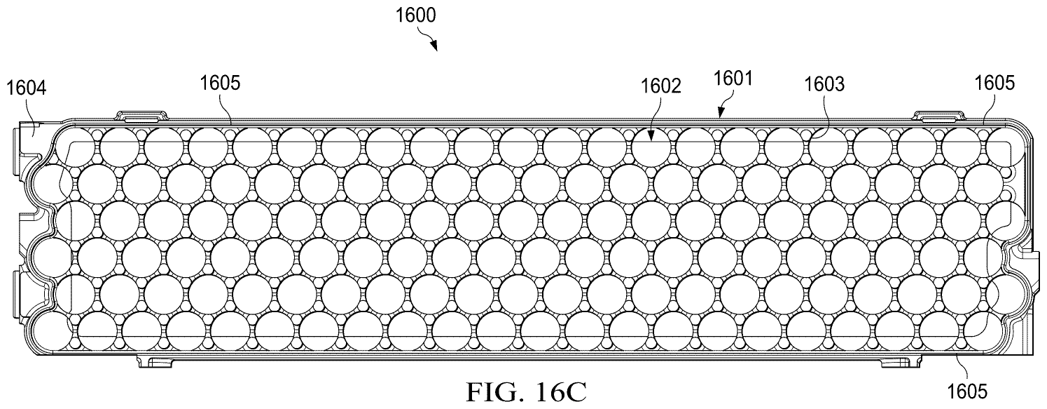

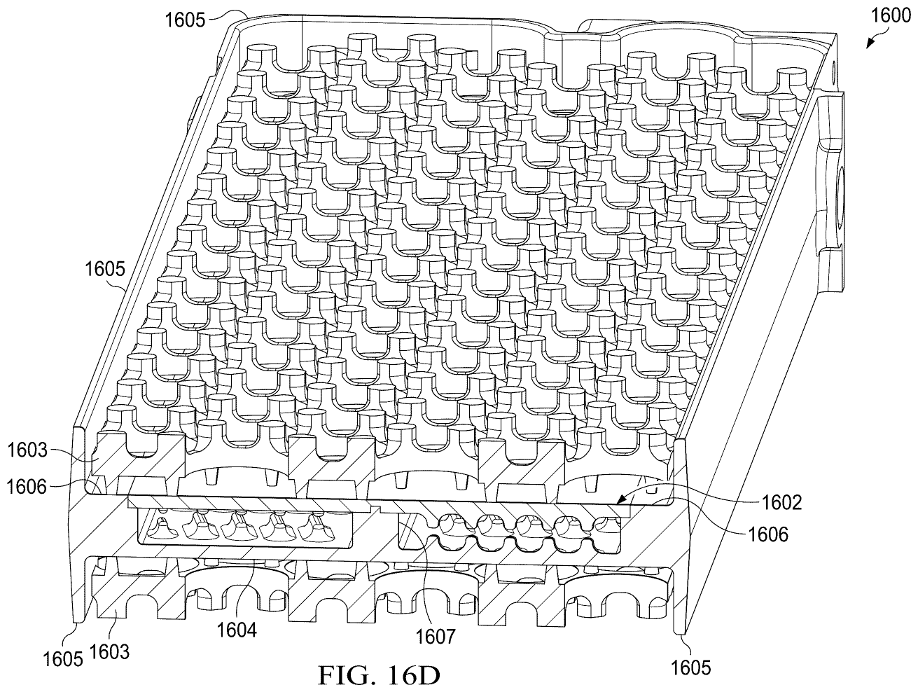

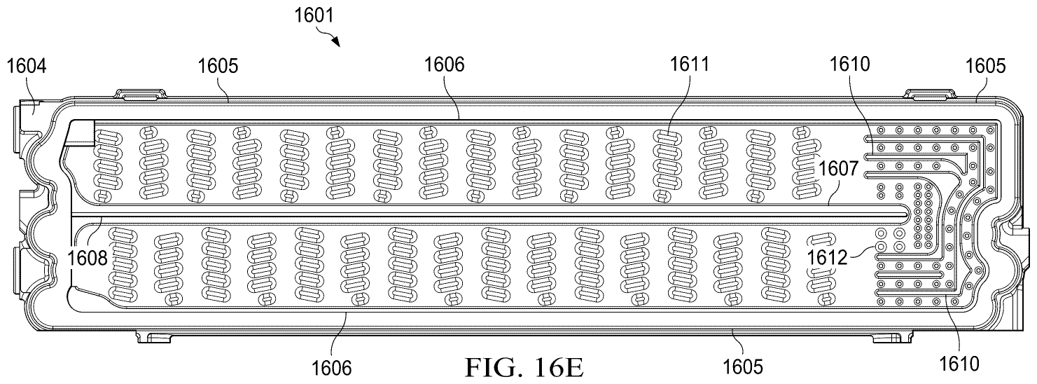

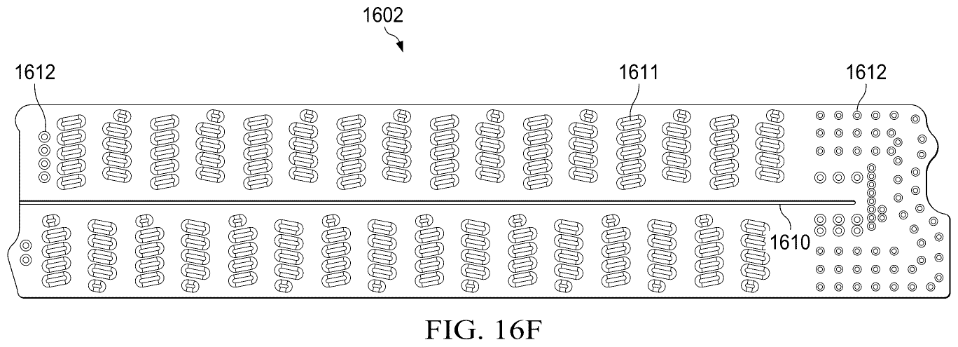

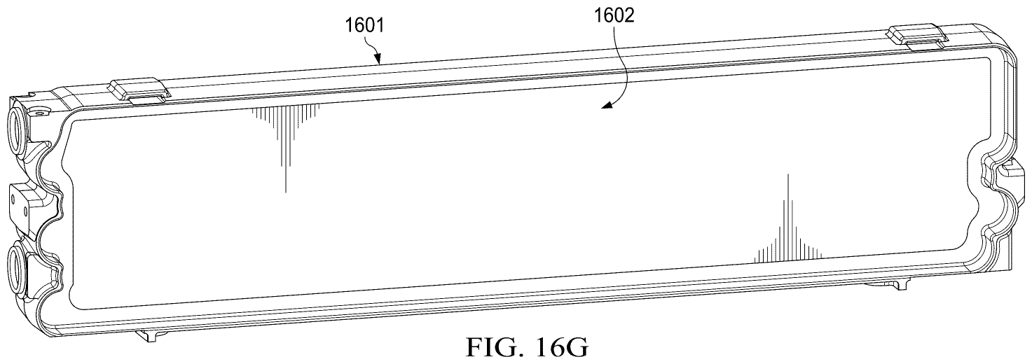

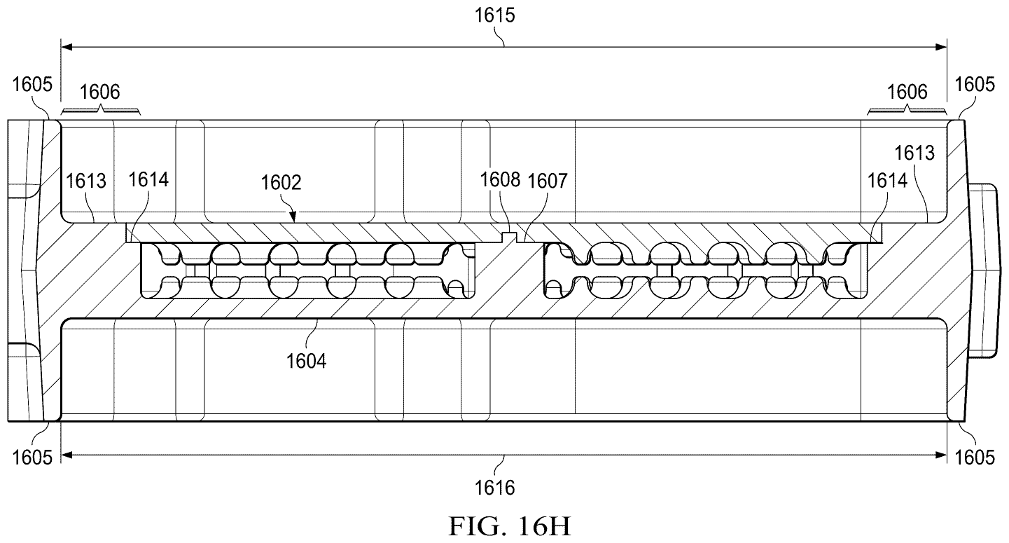

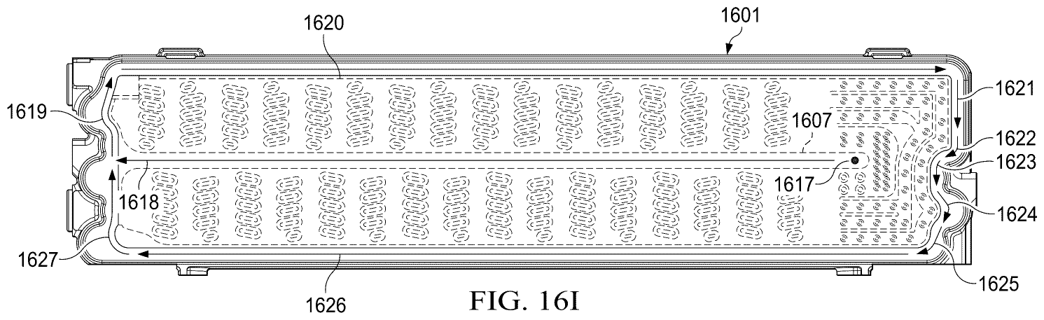

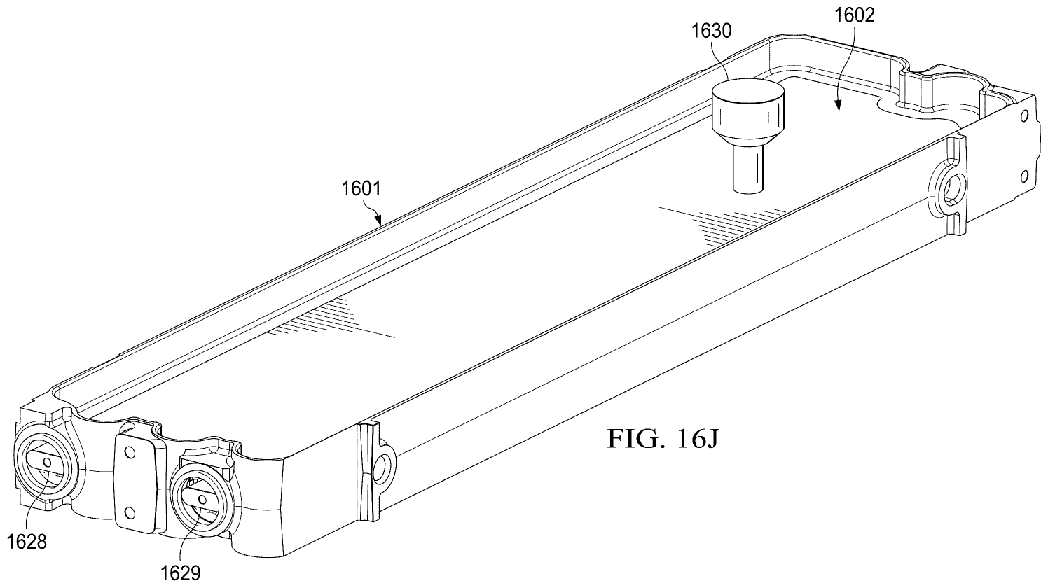

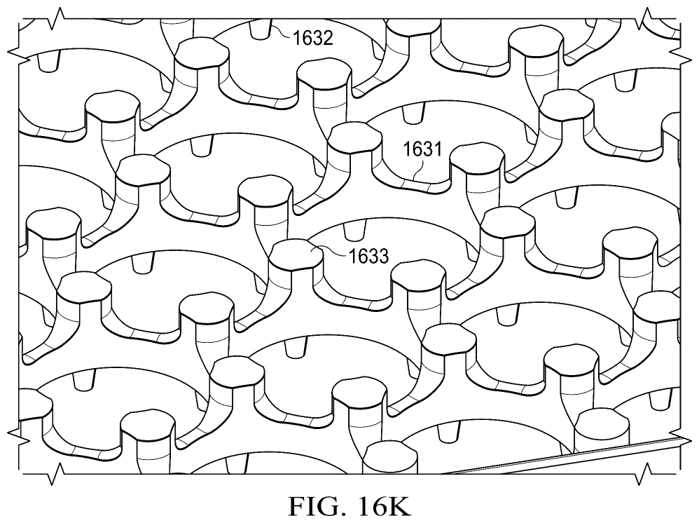

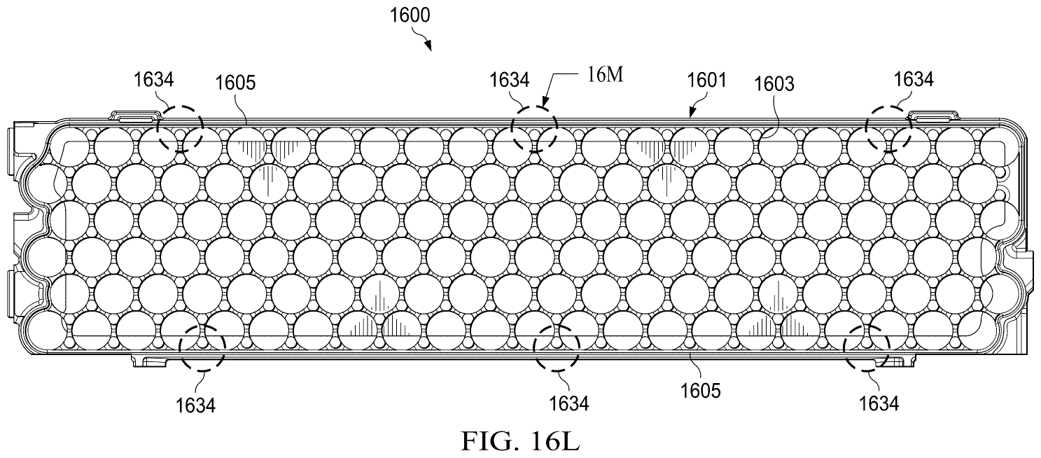

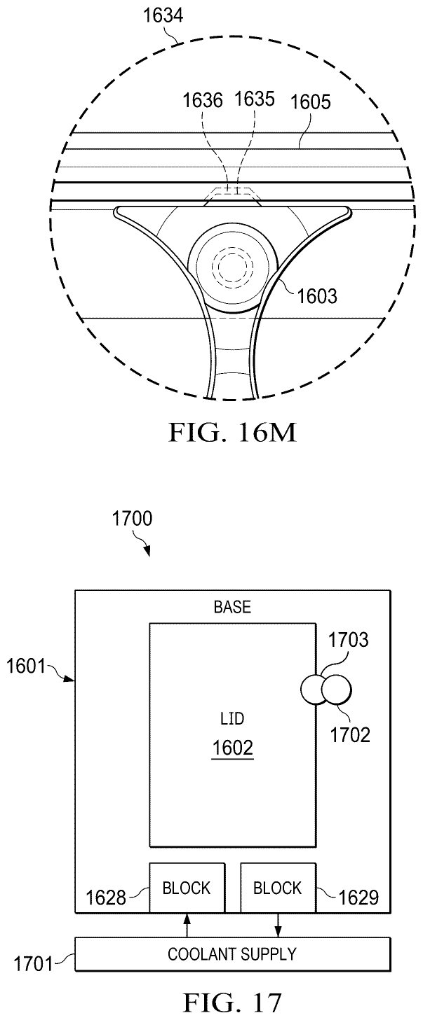

FIGS. 16A through 16M depict various view of a battery cooling plate or components thereof for a battery cooling plate manufactured according to embodiments of the present disclosure, and are used in describing the manufacturing process itself. The embodiment of the battery cooling plate 1600 illustrated in FIGS. 16A through 16M, and the manufacturing process described below, are for illustration and explanation only. FIGS. 16A through 16M do not limit the scope of this disclosure to any particular implementation of a battery cooling plate or manufacturing process.

FIG. 16A is a perspective view of the assembled battery cooling plate 1600, with battery cells for the respective battery module shown in phantom, while FIG. 16B is an exploded perspective view. FIG. 16C is a plan view of one side of the assembled cooling plate 1600, and FIG. 16D is a partial sectional view of the assembled cooling plate 1600. The cooling plate 1600 includes a metallic (e.g., aluminum) base 1601, a metallic (e.g., aluminum) lid 1602, and A and B side plastic honeycomb battery cell receptacle structures 1603. The base 1601 and lid 1602 may be formed by semi-solid die casting, while the honeycomb battery cell receptacle structures 1603 may be formed by injection molding. No sand core is required, and the associated issues described above are avoided. In addition, because of the open nature of the fluid cavities within the cooling plate (prior to the lid 1602 being assembled with the base 1601), burrs formed by machining openings can be removed.

The base 1601 includes a plate 1604 and peripheral walls 1605 protruding from each side and each forming an encircled region therein (one encircled region on side A and another encircled region on side B of the cooling plate 1600), where the lid 1602 and a portion of a stepped ledge 1606 form a “floor” of the recess on the A side and a flat side of the base forms a “floor” for the recess on the B side. The base 1601 includes a recess forming a fluid cavity. On one side of the cooling plate 1600, spaced apart from the peripheral walls 1605, is the stepped ledge 1606. A first “horizontal” surface of the stepped ledge 1606 extends inward from the peripheral walls 1605 for a first distance (forming a first ledge of the stepped ledge 1606), then a second surface extends substantially parallel to the peripheral walls 1605 (“vertically”) for a second distance (which may be approximately equal to a thickness of the lid 1602), and then a third surface of the stepped ledge 1606 extends again inward for a third distance forming a second ledge of the stepped ledge 1606 (which may be narrower than the first ledge), before a remaining surface of the stepped ledge 1606 again extends substantially parallel to the peripheral walls 1605 to a bottom of the recessed region. The width of a first ledge of the stepped ledge 1606 allows for use of a friction stir welding tool, while the second ledge forms a weld surface for the lid 1602 and the lower “vertical” surface of the stepped ledge 1606 defines a periphery of the fluid cavity within the cooling plate 1600. Where alternative joining techniques are employed to secure the lid 1602 to the base 1601, such as laser welding, bonding, adhering, or using screws or other fasteners, the stepped ledge 1606 may be replaced by a single ledge or similar structure for securing the lid 1602. A peninsular lid support rib 1607 extends approximately down a center of the base 1601, at a location corresponding to another weld surface for the lid 1602. The interior lid support rib 1607 may have a projecting flange 1608 received by a counterpart groove 1609 on the lid 1602 when the lid 1602 is assembled with the base 1601.

FIG. 16E is a plan view of one side of the base 1601 for the battery cooling plate 1600, while FIG. 16F is a plan view of an interior side of the lid 1602 for the battery cooling plate 1600. FIG. 16G is a perspective view of the assembled base 1601 and lid 1602 for the cooling plate 1600. The lid 1602 encloses the fluid cavity within the base 1601, for fluid flowing in and out via fluid ports on the ends of the cooling plate 1600. When the lid 1602 is assembled with the base 1601, peripheral edges of the interior surface of the lid 1602 (that is, the surface facing the viewer in FIG. 16F) rest on the second ledge portion of the peripheral stepped ledges 1606, and a central portion of the interior surface of the lid 1602 rests on the upper surface of the central lid support rib 1607 with the projecting flange 1608 received by the groove 1609.

FIG. 16H is a cross-sectional view of the assembled base 1601 and lid 1602 for the cooling plate 1600. FIG. 16I depicts the friction stir welding path during assembly of the base 1601 and the lid 1602. As discussed above, the peripheral stepped ledge 1606 on the base 1601 and inside the peripheral walls 1605 includes a first ledge 1613 and a second ledge 1614. A width of the first ledge 1613 is selected to maintain a distance (e.g., based on dimensions of the welding tool) to the peripheral wall 1605 for the welding path, which follows the second ledge 1614. The second ledge 1614 and the central lid support rib 1607 should have a width designed to meet welding pressure of the friction stir welding, and both structures ensure proper mixing of the metallic (aluminum) material during friction stir welding. The projecting flange 1608 helps ensure that the lid 1602 will not collapse when pressure is applied during friction stir welding. In addition, the honeycomb-to-base interface area 1615 between the peripheral walls 1605 on the side of the cooling plate 1600 to which lid 1602 is welded (i.e., on the welding side or “A” side) is designed wider than the counterpart honeycomb-to-base interface arca 1616 (on the “B”) side to accommodate thermal expansion due to the heat generated from welding. Once the part is cooled after welding, the final dimension allows the correct fit of honeycomb structure.

As illustrated in FIG. 161, the path for friction stir welding of the lid 1602 to the base 1601 begins 1617 at the freestanding end of the central lid support rib 1607 and proceeds down a length 1618 of the central lid support rib 1607, over the projecting flange 1608. The friction stir welding then proceeds along a path 1619 across an end of the base 1601 toward a long edge, along a path 1620 parallel to a long edge of the base 1601, along a series of paths 1621, 1622, 1623, 1624, and 1625 across the other end of the base 1601, along a path 1626 parallel to an opposite long edge of the base 1601, and along a path 1627 from the opposite long edge back toward the central lid support rib 1607.

FIG. 16J illustrates friction stir welding of the lid 1602 to the base 1601. To ensure good welding quality and to avoid welding defects, two additional steel blocks 1628 and 1629 are placed to seal the cooling plate fluid inlet and outlet, to provide support and avoid collapse of the lid 1602 due to the pressure exerted during the friction stir welding. Both blocks 1628 and 1629 have holes, with one block being connected (e.g., by a hose) to a cool air or water (coolant) supply. Circulation of the coolant inside the cooling plate fluid cavity transfers heat and cools the cooling plate as heat is generated during the friction stir welding process (which utilizes temperatures up to about 300° C.). By providing the coolant inside the fluid cavity, the welding work piece remains at room temperature to avoid warpage, a primary reason for welding defects from friction stir welding. An air blower is also placed next to the friction stir welding tool 1630 (e.g., a robot available from FANUC Corporation, or a computer numerical control (CNC) machine), for facilitating the work piece cooling during the welding process. Blocks 1628 and 1629 are removed once the welding is complete.

Referring back to FIGS. 16E and 16F, the surfaces of the plate 1604 for the base 1601 include, inside the fluid cavity, ribs 1610 designed to guide the fluid flow inside the respective fluid cavity to the bottom of the cooling plate 1600, where heat generated from this area by the battery cells can be transferred out. Two generally U-shaped ribs 1610, one straight rib 1610, and one generally L-shaped rib 1610 are depicted in FIG. 16E. The same surfaces of at the bottom of the fluid cavities on the plate 1604 further include patterned arrays of fins 1611 and dimples 1612 designed to create turbulent fluid flow, to increase the heat transfer rate and reduce the pressure drop of fluid flowing inside the corresponding fluid cavity. Counterpart fins 1611 and dimples 1612 are formed on the interior surface of the lid 1602, in patterns complementary (for purposes of creating turbulent fluid flow) to those inside the fluid cavities.

As shown in FIG. 16C and 16D, the honeycomb battery cell receptacle structures 1603 fit inside the peripheral walls 1605 of the base 1601, over the lid 1602 on one side and on the plate 1604 on the other. FIG. 16K is an enlarged view of a portion of the honeycomb battery cell receptacle structures 1603. Each battery cell pocket has a circular cross-section formed by a web 1631 of the molded plastic. Downwardly extending legs 1632 protrude from the bottom of the web 1631 at each point adjoining three adjacent battery cell pockets, and upwardly extending posts 1633 project from the top at the same points. The bottom legs 1632 space the web 1631 from the underlying surface and facilitate cell adhesive dispensing and curing, which will yield faster assembly time, and better quality (more uniform adhesive distribution, and better aeration of adhesive). The draft angel provided by posts 1633 facilitates dropping of battery cells into the respective battery cell pocket during assembly.

FIG. 16L is a plan view illustrating how the honeycomb battery cell receptacle structures 1603 are initially secured to the cooling plate 1600 during assembly. At a plurality of locations 1634 (six, in the example depicted) around a peripheral edge of each honeycomb battery cell receptacle structure 1603, a snap fit projections or comparable structure is provided. FIG. 16M is an enlarged and simplified view illustrating the snap fit. The snap fit feature ensures structural sturdiness once the honeycomb battery cell receptacle structures 1603 is installed, without falling off during transportation of the assembled cooling plate 1600 or during battery cell assembly on the cooling plate 1600. In each location 1634 of a snap fit feature, a protrusion 1635 from a peripheral edge surface of the honeycomb battery cell receptacle structure 1603 is received by a correspondingly shaped indentation 1636 within the peripheral walls 1605 of the base 1601.

FIG. 17 diagrammatically illustrates a manufacturing assembly for friction stir welding of the lid to the base on a cooling plate according to embodiments of the present disclosure. The embodiment of the manufacturing assembly 1700 illustrated in FIG. 17, and the manufacturing process described below, are for illustration and explanation only. FIG. 17 does not limit the scope of this disclosure to any particular implementation of a battery cooling plate or manufacturing process.

As described above, during assembly of the lid 1602 to the base 1601 for the cooling plate, blocks 1628 and 1629 are inserted into the cooling plate fluid inlet and outlet to support the lid 1602 during welding. During welding, the holes through blocks 1628 and 1629 are connected by hoses to a coolant supply, such as an air compressor or a fluid pump. A blower 1702 is positioned proximate to the head 1703 for the welding tool used for friction stir welding of the lid 1602 to the base 1601.

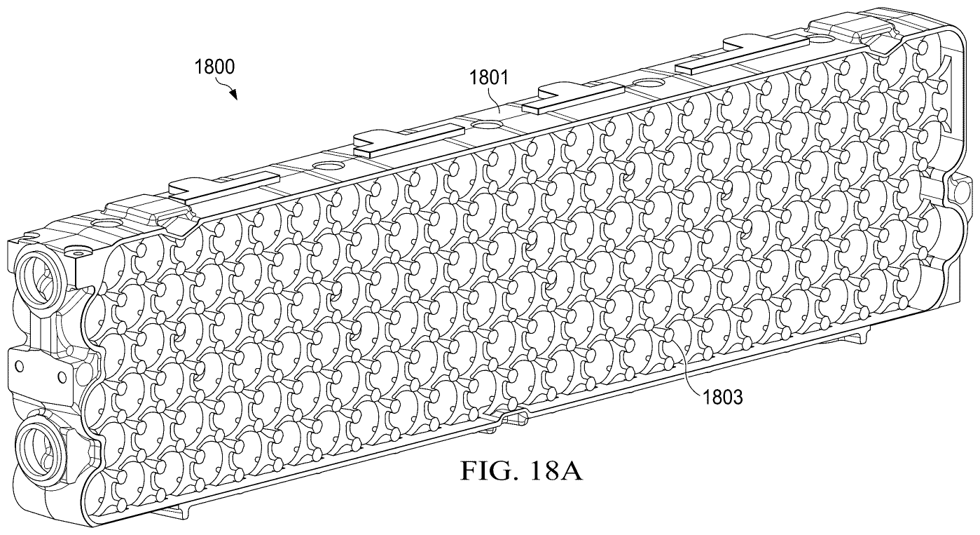

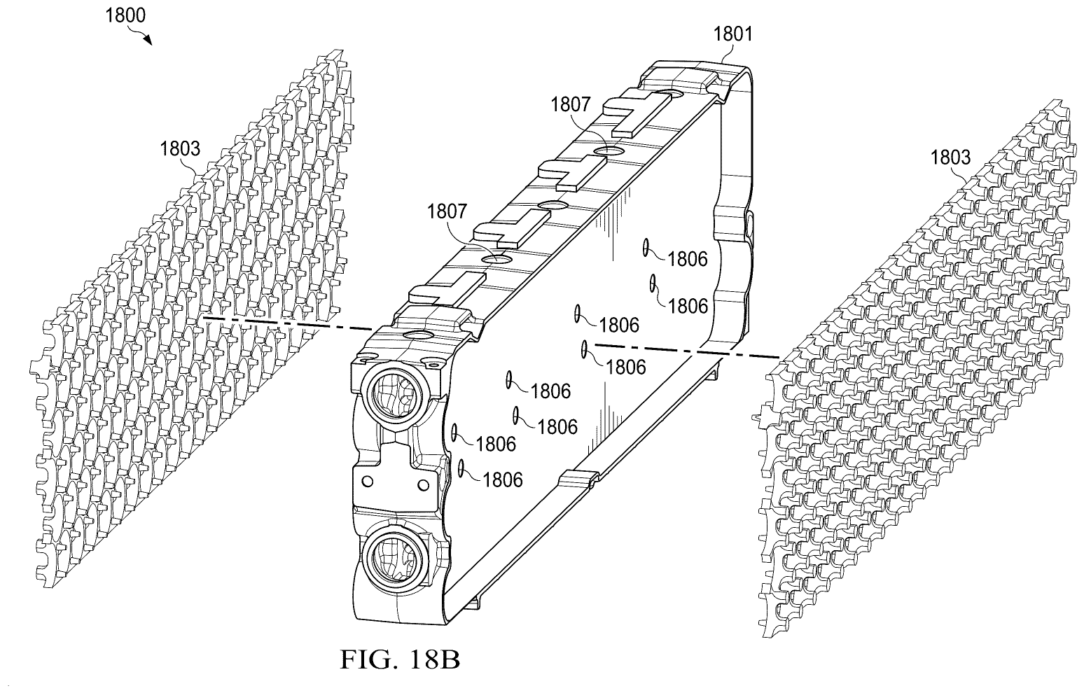

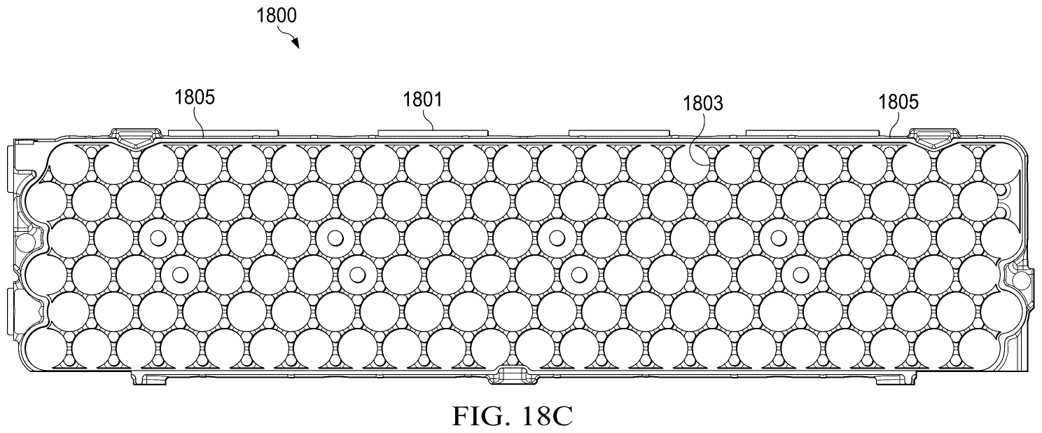

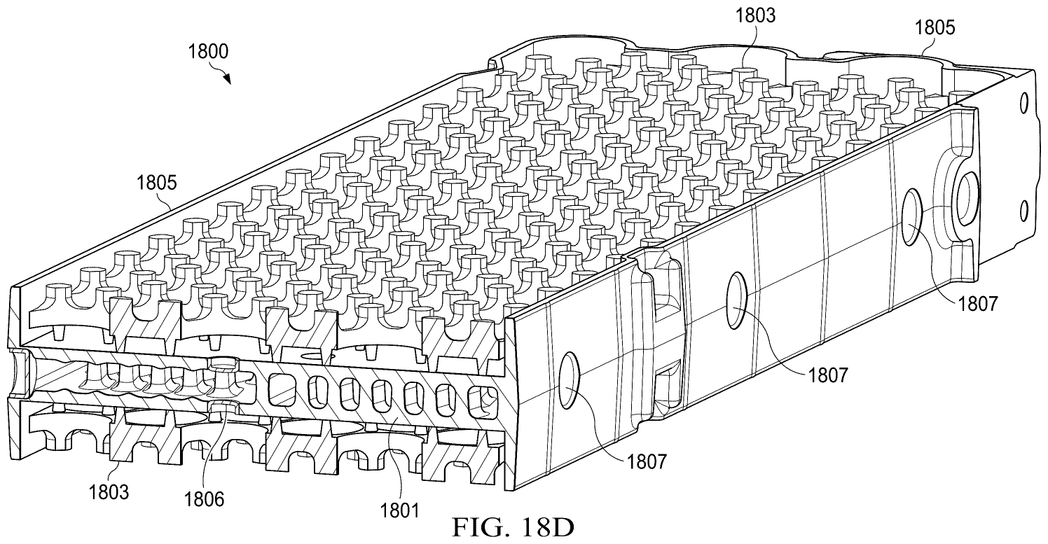

FIGS. 18A through 18D depict various view of a battery cooling plate manufactured according to alternative embodiments of the present disclosure. The alternative embodiment of the battery cooling plate 1800 illustrated in FIGS. 18A through 18D, and the manufacturing process described below, are for illustration and explanation only. FIGS. 18A through 18D do not limit the scope of this disclosure to any particular implementation of a battery cooling plate or manufacturing process.

FIG. 18A is a perspective view of the assembled battery cooling plate 1800, without battery cells, while FIG. 18B is an exploded perspective view. FIG. 18C is a plan view of one side of the assembled cooling plate 1800, and FIG. 18D is a partial sectional view of the assembled cooling plate 1800. In the embodiment of FIGS. 18A-18D, a monolithic, metallic body 1801 for the cooling plate 1800 is formed by gravity casting (e.g., using a sand core as described above) and CNC machining of the fluid inlet and outlet and holes 1806, 1807 corresponding respectively to sand core face protrusions and peripheral edge protrusions. The body 1801 includes an internal fluid cavity, peripheral walls 1805 protruding from each side, and A and B side plastic honeycomb battery cell receptacle structures 1803 within the recesses formed by the peripheral walls 1805. The embodiment of FIGS. 18A-18D therefore avoids all of the issues discussed herein associated with forming, machining, e-coating, and powder coating battery cell pockets integrally formed on the cooling plate.

EV battery cooling plate designs from different original equipment manufacturers (OEMs) are predominantly only for a cell-to-pack type of the architecture designed based on sheet metals. Those types of cooling plates are typically not structural and multifunctional, but instead mainly just provide thermal management for the high voltage (HV) battery modules based on liquid coolant, to heat or cool the battery pack under different vehicle operation cases. In general, the cooling plate designs are composed of top and bottom sheet metals. The top plate is typically flat for contacting the battery cell, while the bottom plate is usually stamped with coolant flow channels for increasing the heat transfer coefficient. Both plates can be either welded using brazing process or combined using adhesives and laser welding.

For multifunctional cooling plates for EV battery application, the design is typically composed with multiple parts including extruded aluminum for coolant channels, die cast aluminum front and rear portions to be friction stir welded together with the extruded piece.

Advantages of the design described in connection with FIGS. 16A through 16M or FIGS. 18A through 18D include an increased manufacturability/case of assembly, since each component design is very DFM friendly and tailored for either injection molding or high pressure die casting for mass production purposes. Battery cells are positioned on both sides of the cooling plate, and the concept can be further applied to 46 series cylindrical cells such as 4680, 4695, 46120, and prismatic cell. The design disclosed herein is multifunctional and versatile, meeting various vehicle architectural needs since the cooling plate is not just for heating and cooling the battery cell but also serves as a structural component that can be highly integrated into the vehicle platform, to meet various configuration needs: cell-to-chassis (CTC); cell-to-module (CTM); and cell-to-pack (CTP), all of which help reduce costs from vehicle level perspective.

Compared to the design of FIGS. 3 and 3A-3B, the designs of FIGS. 16A through 16M or FIGS. 18A through 18D is much easier to integrate into battery modules/pack based on different cell type (cylindrical, pouch, and prismatic shaped cells), since the honeycomb battery cell receptacle structures can be easily arranged to accommodate battery cell shapes other than cylindrical. and the designs of FIGS. 16A through 16M or FIGS. 18A through 18D also facilitate implementing cell busbar connections to meet different configuration needs. The design can be manufactured with less of an initial tooling investment than designs that are casted or stamped. The design of FIGS. 16A through 16M can be machined with friction stir welding, allowing quick turnaround time to evaluate different concepts.

The design of FIGS. 16A through 16M can be made by using regular high pressure design casting with aluminum (B390) material or semi-solid die casting with aluminum (A357-T5) material, based on the strength needs. Parts made by semi-solid die casting typically have higher strength (no porosity) compared to the regular die-casting (with porosity). In this regard, the structural cooling plate design of FIGS. 16A through 16M ensures that the battery pack meets more severe load cases compared to stamped designs.

Depending on the thermal management requirement and/or heat transfer needs based on pack/module design with different capacity needs, coolant fin patterns in the design of FIGS. 16A through 16M can be tailored to meet application needs. With CFD simulation, the fin pattern can be optimized to maximize the heat transfer coefficient and reduce the pressure drop for thermal management of the battery.

It may be advantageous to set forth definitions of certain words and phrases used throughout this patent document. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present disclosure should not be read as implying that any particular element, step, or function is an essential or critical element that must be included in the claim scope. The scope of patented subject matter is defined only by the allowed claims. Moreover, none of the claims invokes 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” or “controller” within a claim is understood and intended to refer to structures known to those skilled in the relevant art, as further modified or enhanced by the features of the claims themselves, and is not intended to invoke 35 U.S.C. § 112(f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A battery module cooling plate, comprising:
a base having a first side and a second side, the base including first walls projecting from a periphery of the base on the first side and second walls projecting from the periphery of the base on the second side, the first side of the base including a recessed region spaced apart from the first walls and forming a fluid cavity;
a lid over the recessed region;
a first honeycomb battery cell receptacle structure within the first walls on the first side of the base and over the lid; and
a second honeycomb battery cell receptacle structure within the second walls on the second side of the base.

2. The battery module cooling plate according to claim 1, wherein the base, the lid, the first honeycomb battery cell receptacle structure, and the second honeycomb battery cell receptacle structure are all separately formed and assembled to function as a single device.

3. The battery module cooling plate according to claim 1, wherein a periphery of the recessed region is spaced apart from the first walls by a distance accommodating a friction stir welding tool head, and
wherein a periphery of the recessed region includes a lip indented by a distance corresponding to a thickness of the lid and projecting under an edge of the lid by an amount sufficient for friction stir welding of the lid to the lip of the recessed region in the base.

4. The battery module cooling plate according to claim 3, wherein the recessed region includes a peninsular lid support extending therein, the peninsular lid support having a width sufficient for friction stir welding of the lid to an upper surface of the peninsular lid support.

5. The battery module cooling plate according to claim 4, wherein the peninsular lid support includes a projecting flange received by a counterpart groove within the lid.

6. The battery module cooling plate according to claim 1, wherein a separation between the first walls differs from a separation between the second walls to accommodate thermal expansion during friction stir welding of the lid to the base.

7. The battery module cooling plate according to claim 1, wherein the first and second honeycomb battery cell receptacle structures each include:
an array of battery cell pockets each sized to receive a battery cell;
gaps in the respective honeycomb structure such that fluid can pass from one cell receptacle to another cell receptacle without overflowing the respective honeycomb structure;
tapered walls on each of the battery cell pockets of the respective honeycomb structure which guide the battery cell into position; and
posts extending upwardly around each of the battery cell pockets to facilitate guiding of the battery cell into the corresponding battery cell pocket.

8. The battery module cooling plate according to claim 1, wherein the first and second honeycomb battery cell receptacle structures each include mating structures at locations around a periphery, each snap fit projection configured to be received by an indentation in one of the first walls or the second walls, wherein joining of the first and second honeycomb battery cell receptacle structures with the base employs interference between the mating structures of the first and second honeycomb battery cell receptacle structures and the base.

9. A battery module including the battery module cooling plate according to claim 1, the battery module further comprising:
a battery cell within each battery cell pocket of the first and second honeycomb battery cell receptacle structures; and
adhesive securing each battery cell within the corresponding battery cell pocket.

10. An electric vehicle including the battery module according to claim 9, the electric vehicle further comprising:
a platform supporting the battery module;
a cabin mounted on the platform; and
wheels rotatably mounted on the platform.

11. A battery module cooling plate, comprising:
a base having a first side and a second side, the base including first walls projecting from a periphery of the base around a first floor on the first side and second walls projecting from the periphery of the base around a second floor on the second side, the first floor and the second floor forming a fluid cavity therebetween;
a first honeycomb battery cell receptacle structure within the first walls on the first side of the base and over the first floor; and
a second honeycomb battery cell receptacle structure within the second walls on the second side and over the second floor.

12. The battery module cooling plate according to claim 11, wherein the base comprises a ledge inside the first walls and surrounding a recessed region, the battery module cooling plate further comprising:
a lid fitting inside the ledge and over the recessed region to enclose the fluid cavity,
wherein the lid and the ledge form the first floor, and wherein a surface of the base forms the second floor.

13. The battery module cooling plate according to claim 11, wherein the first honeycomb battery cell receptacle structure and the second honeycomb battery cell receptacle structure are separately formed from the base and comprise a different material from the base.

14. A battery module including the battery module cooling plate according to claim 11, the battery module further comprising:
a battery cell within each battery cell pocket of the first and second honeycomb battery cell receptacle structures; and
adhesive securing each battery cell within the corresponding battery cell pocket.

15. An electric vehicle including the battery module according to claim 14, the electric vehicle further comprising:
a platform supporting the battery module;
a cabin mounted on the platform; and
wheels rotatably mounted on the platform.

16. A method of producing a battery module cooling plate, the method comprising:
forming a base having a first side and a second side, the base including first walls projecting from a periphery of the base around a first floor on the first side and second walls projecting from the periphery of the base around a second floor on the second side, the first floor and the second floor forming a fluid cavity therebetween;
mounting a first honeycomb battery cell receptacle structure within the first walls on the first side of the base and over the first floor; and
mounting a second honeycomb battery cell receptacle structure within the second walls on the second side and over the second floor.

17. The method according to claim 16, wherein the base comprises a ledge inside the first walls and surrounding a recessed region, the method further comprising:
forming a lid fitting inside the ledge; and
securing the lid over the recessed region to enclose the fluid cavity,
wherein the lid and the ledge form the first floor, and wherein a surface of the base forms the second floor.

18. The method according to claim 16, further comprising:
forming the first honeycomb battery cell receptacle structure and the second honeycomb battery cell receptacle structure separately from the base, and from a different material from the base.

19. A method of producing a battery module including producing the battery module cooling plate according to the method of claim 16, the method further comprising:
dropping a battery cell within each battery cell pocket of the first and second honeycomb battery cell receptacle structures; and
securing each battery cell within the corresponding battery cell pocket using adhesive.

20. A method of manufacturing an electric vehicle including the method of producing the battery module according to claim 19, the method further comprising:
supporting the battery module within a platform;
mounting a cabin on the platform; and
rotatably mounting wheels on the platform.
